(19) United States
(12) Patent Application Publication
(10) Pub. No.: US 2024/0416650 A1
(43) Pub. Date: Dec. 19, 2024

(54) HIGH-FREQUENCY ELECTROHYDRODYNAMIC PRINTING

(71) Applicant: The Regents of the University of Michigan, Ann Arbor, MI (US)

(72) Inventors: Kira BARTON, Ann Arbor, MI (US); Lai Yu Leo TSE, Ann Arbor, MI (US)

(21) Appl. No.: 18/706,670

(22) PCT Filed: Nov. 1, 2021
(86) PCT No.: PCT/US2021/057585

§ 371 Date: May 1, 2024

(51) Int. Cl. B41J 2/085; B41J 2/03; B41J 2/095

(52) U.S. Cl. CPC B41J 2/085; B41J 2/095; B41J 2002/031

(57) ABSTRACT

The jetting frequency of droplets of printing fluid from a nozzle of an electrohydrodynamic printer is increased by 50% or more over previous e-jet printers. The charging electrode is strategically arranged to locate layers of material in the gap between the electrode and an extraction surface to provide a breakdown voltage in the gap that is higher than that of air. By locating a tip of the charging electrode inside the ink nozzle, non-conductive printing fluid in the nozzle and/or a non-conductive nozzle wall can provide dielectric strength in the gap that is relatively high, thereby increasing the maximum voltage of the extraction field. The printer offers other advantages, even when there are no high breakdown voltage materials in the gap between the electrode and extraction surface.

This invention was made with government support under IIP1918754 awarded by the National Science Foundation. The government has certain rights in the invention.

### TECHNICAL FIELD

The present disclosure relates to improvements in electrohydrodynamic printing.

### BACKGROUND

Electrohydrodynamic printing, also known as e-jet printing, is a printing technique that relies on an electric field to extract charged or polarized printing fluid from a printing nozzle for deposition on a printing surface. E-jet printing is capable of very high-resolution printing compared to other drop-on-demand or stream printing methods with droplet size and spatial accuracy on a sub-micron or nanometer scale. Early e-jet printing was limited to electrically conductive printing surfaces because the printing surface was one of the electrodes between which the electric field was produced. Consistency with the electric field was also problematic due to the deposited ink causing interference with the field as printing progressed. U.S. Pat. No. 9,415,590 to Barton, et al. addressed these and other problems via clever ink extraction and directing techniques that did not rely on a conductive printing surface.

### SUMMARY

In accordance with one or more embodiments, an electrohydrodynamic printer includes a nozzle and an electrode. The nozzle has extraction opening, and the printer is configured to provide printing fluid in the nozzle and at the extraction opening. The electrode is configured to operate at a first electrical potential to charge the printing fluid in the nozzle and to form an extraction field between the electrode and an extraction surface at a second electrical potential with the extraction opening in the extraction field. Charged printing fluid is extracted from the nozzle by the extraction field through the extraction opening for deposition on a printing surface. A gap is defined at a smallest distance between the electrode and the extraction surface, and the printer is configured to provide, in that gap, at least one layer of material having a dielectric strength greater than a dielectric strength of air.

In various embodiments, the electrode is inside the nozzle and at least partially surrounded by the printing fluid in the nozzle such that the at least one layer of material comprises a layer of the printing fluid.

In various embodiments, the electrode is inside the nozzle and the nozzle is formed from a non-conductive material such that the at least one layer of material includes a portion of the nozzle.

In various embodiments, the at least one layer of material includes a layer of dielectric gas flowing through the gap.

In various embodiments, the printer includes an extractor laterally spaced from the nozzle, and the extractor provides the extraction surface at the second electrical potential.

In various embodiments, the at least one layer of material includes a non-gaseous layer in contact with the extraction surface.

In various embodiments, the printer includes a self-cleaning extractor and the at least one layer of material is a liquid cleaning fluid.

In various embodiments, the printer includes a gas nozzle configured to discharge a jet of gas that directs extracted printing fluid toward the printing surface.

In various embodiments, the at least one layer of material includes a jet of gas that directs extracted printing fluid toward the printing surface.

In various embodiments, the at least one layer of material includes a jet of heated gas that directs extracted printing fluid toward the printing surface.

In various embodiments, the printing surface provides an electrically conductive surface as the extraction surface at the second electrical potential.

In various embodiments, the printing surface provides an electrically non-conductive surface as the extraction surface at the second electrical potential.

In various embodiments, the electrode is inside the nozzle and does not extend through the extraction opening.

In various embodiments, an end of the electrode is spaced from the extraction opening by an amount greater than zero and less than or equal to 100 microns.

In various embodiments, the electrode has a cross-sectional dimension of less than 30 microns.

In various embodiments, the electrode is tapered toward an end and has a cross-sectional dimension of less than 20 microns.

In various embodiments, the at least one layer of material comprises a non-conductive material of the nozzle and non-conductive printing fluid.

In various embodiments, the printing fluid in the nozzle is heated.

In various embodiments, the nozzle is non-conductive, the extraction opening has a size, the nozzle is spaced from the printing surface by a distance, and the printer has a maximum jetting frequency that is at least 50% greater than a jetting frequency obtained with a conductive nozzle containing the same printing fluid, having the same size extraction opening, and being spaced from the printing surface by the same distance.

In various embodiments, a method of increasing the jetting frequency of an electrohydrodynamic printer includes charging printing fluid in a nozzle of the printer and forming an extraction field between the electrode and an extraction surface spaced from the electrode by a gap. The charging step includes using an electrode at a first electrical potential. An extraction opening of the nozzle is located in the extraction field so that charged printing fluid is extracted from the nozzle through the extraction opening for deposition on a printing surface. At least one of the following is located in the gap when the extraction field is present: non-conductive printing fluid, non-conductive material of the nozzle, a dielectric gas, and a layer of cleaning fluid flowing along the extraction surface.

In various embodiments, an electrohydrodynamic printer includes a nozzle and an electrode. The nozzle has an extraction opening, and the printer is configured to provide printing fluid in the nozzle and at the extraction opening. The electrode operates at a first electrical potential to charge the printing fluid in the nozzle and to form an extraction field between the electrode and an extraction surface at a second electrical potential with the extraction opening in the extraction field. Charged printing fluid is extracted from the nozzle by the extraction field through the extraction opening for deposition on a printing surface. The electrode is inside the nozzle, and an end of the electrode closest to the extraction opening is immersed in the printing fluid in the nozzle. The nozzle may be electrically non-conductive.

Various aspects, embodiments, examples, features and alternatives set forth in the preceding paragraphs, in the claims, and/or in the following description and drawings may be taken independently or in any combination thereof. For example, features disclosed in connection with one embodiment are applicable to all embodiments in the absence of incompatibility of features.

### BRIEF DESCRIPTION OF THE DRAWINGS

FIG. 1 is a schematic cross-sectional side view of an embodiment of an electrohydrodynamic printer;

FIG. 2 is an enlarged view of a portion of FIG. 1;

FIG. 3 is a schematic cross-sectional side view of another embodiment of the electrohydrodynamic printer; and

FIG. 4 is a schematic cross-sectional side view of another embodiment of the electrohydrodynamic printer.

### DESCRIPTION OF EMBODIMENTS

Described below are an electrohydrodynamic print head, printer, and method of printing that enables higher jetting frequencies than were previously possible. The higher frequencies are made possible via a higher ink extraction field strength, which is achieved by increasing the dielectric strength of the materials present in the extraction field relative to those present in previous e-jet printers.

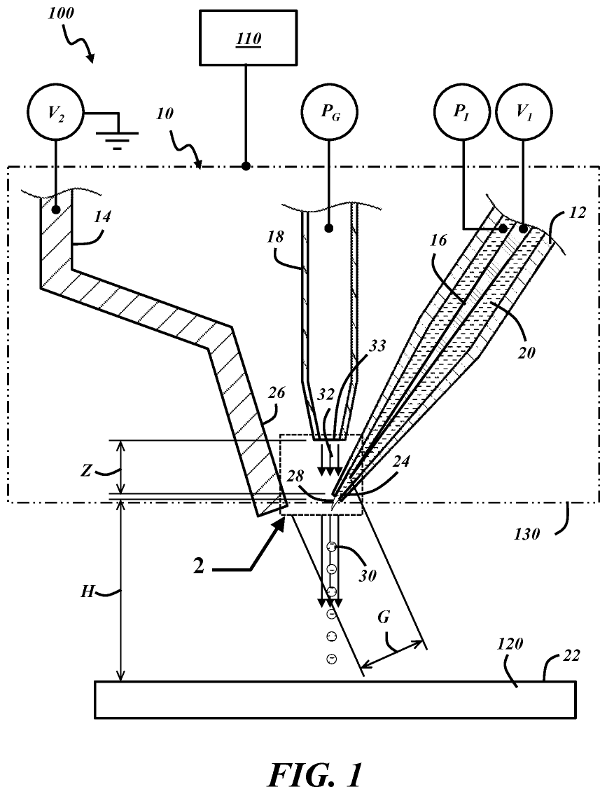

With reference to FIG. 1, a portion of an electrohydrodynamic (i.e., e-jet) print head 10 is illustrated in a side cross-sectional view. The illustrated print head 10 includes an ink nozzle 12, an extractor 14, an electrode 16, and a gas nozzle 18 arranged together to extract printing fluid 20 from the ink nozzle for deposition on a printing surface 22. The printing fluid 20 may be referred to as an “ink” in the following description and is intended to encompass any fluid that flows under pressure and can be solidified after deposition. Solidification can be via various mechanisms, such as solvent evaporation, chemical reaction, cooling, or sintering. In some cases, the printing fluid 20 is a functional ink, which is a printing fluid that provides a function other than coloration once solidified on the printing surface 22 on which it is printed. Examples of such functions include electrical conductivity, dielectric properties, adhesive properties, physical structure (e.g., stiffness, elasticity, or abrasion resistance), electromagnetic shielding or filtering, optical properties, electroluminescence, bioactivity, etc.

The print head 10 may be part of a larger e-jet printer or printing system 100, which may include a movement system 110 configured to provide relative movement between the print head and the printing surface 22 such that the print head can be guided along a deposition pattern or path defined over a printing substrate 120 and/or over previously deposited printing fluid as the printing surface 22. Multi-axis movement systems are generally known and may include axis-dedicated servos, guides, wheels, gears, belts, etc. One example of a suitable movement system 110 is disclosed by Barton et al. in U.S. Pat. No. 9,415,590. The movement system 110 may be configured to move the print head 10 and/or a platform-supported substrate 120 back and forth along a horizontal axis while incrementally moving in a perpendicular direction after each pass of the print head. Or the print head 10 can be configured to move in any direction along a plane or three-dimensional contour while the printing surface 22 is held stationary. The print head 10 and/or the printing surface 22 may be configured for relative translational movement in up to all three cartesian coordinate directions, for rotational movement about the associated axes, and for any combination of such movements to allow the print head to deliver printing fluid in any direction and along any path on a substrate of any shape. The print head 10 could be affixed to the end of a robotic arm, for example, to form the printer 100.

The print head 10 may also include a housing 130 including electrical, pneumatic, and/or hydraulic connectors for removably connecting individual print head components to one or more voltage sources, electrical ground, controllers, pressure sources, gas sources, liquid sources, vacuum, ink source, etc. This list is non-exhaustive, and skilled artisans will appreciate that other e-jet printer components may be included or omitted depending on the specific application. Such a housing 130 may also support the illustrated print head components, including at least the ink nozzle 12, extractor 14, electrode 16, and gas nozzle 18, so that they all move together as one with their respective spatial relationships being constant during a given print cycle.

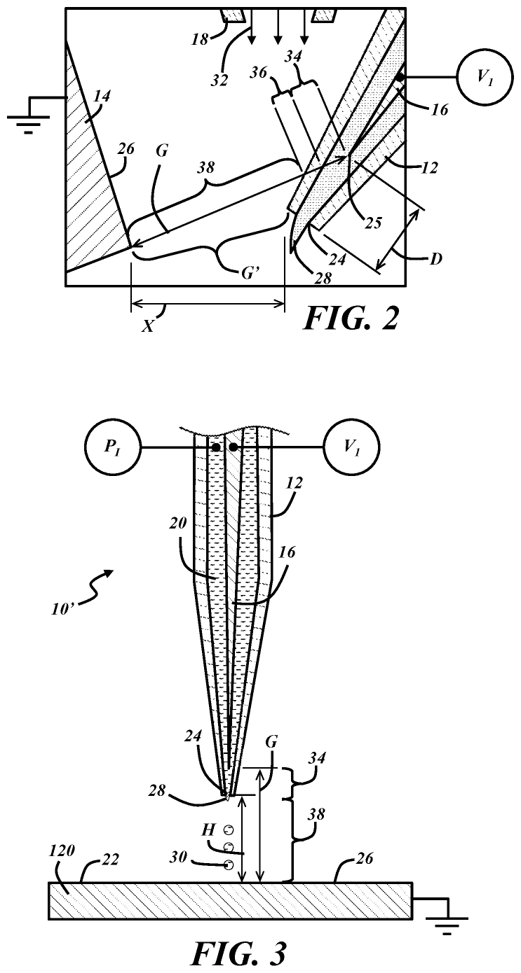

The illustrated ink nozzle 12 includes an extraction opening 24 at a tapered end or tip of the nozzle. There is no requirement that the nozzle 12 is tapered, however. The system 100 is configured to provide the printing fluid 20 inside the nozzle 12 and at the extraction opening 24. At least a portion of the electrode 16 is inside the nozzle 12 where it is in contact with and at least partially surrounded by the printing fluid 20. With additional reference to the enlarged view of FIG. 2, the illustrated electrode 16 is concentric with the nozzle 12 and tapered, with its diameter decreasing as it extends closer to the extraction opening 24. In various embodiments, a tip or distal end 25 of the electrode 16 is inside the nozzle 12 and in full-surface contact with the printing fluid 20 in the nozzle. The tip 25 of the electrode 16 is spaced from the extraction opening in the axial direction by an amount (D) greater than zero and less than or equal to 250 μm. Preferably, the distance (D) is greater than or equal to 50 μm and less than or equal to 200 μm. In a specific embodiment, the distance (D) is about 100 μm.

The electrode 16 operates at a first electrical potential (V₁) and thereby charges the printing fluid 20 in the nozzle 12. An electric field is generated between the electrode 16 and an extraction surface 26, which operates at a second electrical potential (V₂) that is different from the first potential (V₁). The extraction surface 26 is provided by the extractor 14 in this case. The extractor 14 may be a metal (e.g., copper) or other conductive wire or block that extends toward the ink nozzle 12 and electrode 16 to provide the extraction surface 26. In this particular example, a positive voltage (V₁) is applied to the electrode 16 and the extractor 14 is at electrical ground. The extraction opening 24 is located within the electric field formed between the extractor 14 and electrode 16. The positively charged printing fluid 20 in the nozzle 12 is thus attracted toward the 20) extractor 14 and may form a meniscus or Taylor cone 28 that protrudes from the nozzle 12 through the extraction opening 24. When the strength of the electric field at the extraction opening 24 is at or above a critical value, the field is an extraction field and a droplet 30 of printing fluid is extracted from the nozzle 12 for deposition on the printing surface 22. A small backpressure (P₁) may be applied to the printing fluid 20 in the nozzle 12 to ensure that the printing fluid is continuously replenished at the extraction opening 24 so that subsequent droplets 30 are extracted by the extraction field for deposition on the printing surface 22. In manufacturing settings, the backpressure should be sufficiently small so that the printing fluid does not ooze from the nozzle between printing cycles (e.g., 0.1-0.2 psi or less).

In the example of FIGS. 1 and 2, the gas nozzle 18 provides a jet of gas 32 which acts as a directionality field in which the droplets 30 of printing fluid travel to the printing surface 22. In one suitable example, the gas nozzle 18 has a gas discharge opening 33 with a diameter in a range from 40 μm to 60 μm and the gas in the nozzle 18 is pressurized at about 5 psi. Different gas nozzle sizes may be used with gas pressure adjusted accordingly to achieve the proper gas jet velocity. Here, a central axis of the gas nozzle 18 and jet 32 is perpendicular to the printing surface 22 and a central axis of the ink nozzle 12 forms an oblique angle with the gas nozzle axis and with the printing surface. The extraction opening 24 of the ink nozzle is between the printing surface 22 and the gas nozzle 18 and within the projected area of the gas discharge opening 33, which is spaced from the ink nozzle 12 by an amount (Z). The distance (Z) may be in a range from 50 μm to 500 μm. In a particular embodiment, the distance (Z) between the extraction opening 24 and the discharge opening 33 of the gas nozzle 18 is about 100 μm as measured in the axial direction of the gas nozzle. A stand-off height (H) is defined between the ink nozzle 12 and the printing surface 22 and may be in a range from 0.5 mm to 1.0 mm in the illustrated embodiment.

A transverse distance (X) between the ink nozzle 12 and the extractor 14 may be in a range from 50 μm to 150 μm, or about 100 μm. A gap (G) is defined at the shortest distance between the electrode 16 and the extraction surface 26. The gap (G) is larger than the transverse distance (X) by virtue of the electrode 16 having its tip 25 within the nozzle 12. The electrode 16 and the extraction surface 26 are arranged with multiple materials in the gap (G) along the shortest distance between the electrode and extraction surface. There are three layers of material 34-38 in the illustrated gap (G). The first layer 34 is formed from the printing fluid 20 in the nozzle 12, the second layer 36 is formed from the nozzle 12, and the third layer 38 is a gaseous layer between the nozzle 12 and the extraction surface 26. At least one of these layers 34-36 has a dielectric strength that is greater than the dielectric strength of air.

Dielectric strength is a property of electrically insulating materials and is given in units of volts per unit length. The breakdown voltage of a given layer of material is a function of the dielectric strength of the material and the distance through the material across which the voltage is applied. The dielectric strength of air is about 3 kV/mm, meaning that, on average, dry air in a gap between a pair of electrodes spaced apart by 1 millimeter will breakdown and form an electrically conductive path between electrodes when a 3-kilovolt potential is applied across the electrodes. The breakdown voltage may be reduced with humidity or other impurities in the air.

This places a process limitation on previously known e-jet printers. In particular, it limits the magnitude of the voltage that can be applied across the ink nozzle and the extraction surface. Previous e-jet printers typically employed an ink nozzle made from an electrical conductor (e.g., copper or stainless steel) or a non-metallic nozzle coated in an electrically conductive material to charge the ink in the nozzle and provide one node of the electric extraction field. In such cases, as illustrated by way of example in FIG. 2, the entire gap (G′) consists of ambient air. As such, the maximum voltage potential between the nozzle and extractor is limited by the dielectric strength of the air and the size of the gap G′ if arcing between the two components is to be avoided. The maximum applied voltage in that case may be less than 300 volts for every 100 microns of gap (G′).

In the disclosed print head 10, at least a portion of the electrode 16 is inside the nozzle 12, thus facilitating use of the wall of the nozzle 12, the printing fluid 20, and/or the jet of gas 32 to increase the effective breakdown threshold of the materials in the gap (G). The nozzle 12 may for example be made from a glass material providing the second layer 36 of the illustrated example. Common glass materials have a dielectric strength of about 10-15 kV/mm, or about 3 to 5 times that of air. In some cases, the nozzle 12 is made from a borosilicate glass with an even higher dielectric strength in a range between 20-40 kV/mm. The nozzle 12 may alternatively be made from a plastic material or ceramic material. High-density polyethylene (HPDE) and many other polymers have a dielectric strength of about 20 kV/mm or higher. In various embodiments, the nozzle 12 is formed at least in part from a material having an average dielectric strength of 5 kV/mm or higher, 10 kV/mm or higher, or greater than 15 kV/mm.

The disclosed print head 10 is best suited for printing non-conductive printing fluids, such as organic printing fluids. Many organic solvents (e.g., hexane, benzene) have a dielectric strength one the order of greater than 100 kV/mm. As such, printing fluids that use organic solvents as an evaporative carrier of ink solids may provide the first layer 34 of material between the electrode and extraction surface 26 in the illustrated example. Other organic printing fluids capable of providing a higher-than-air breakdown voltage include polymeric printing fluids, oligomeric fluids, and monomeric fluids capable of curing after deposition. One example is a UV-curable adhesive or other non-conductive curable ink. Another example is a UV-curable resin with ceramic powder mixed in for 3D-printing purposes. Another example is a printing fluid including one or more polymers dissolved in an organic solvent. In various embodiments, the printing fluid 20 has an average dielectric strength of 5 kV/mm or higher, 10 kV/mm or higher, 15 kV/mm or higher, 50 kV/mm or higher, or 100 kV/mm or higher.

In embodiments configured to provide a jet of gas 32 to direct extracted droplets 30 of printing fluid toward the printing surface 22, the jetted gas may include or consist essentially of a dielectric gas, or any gas having a dielectric strength greater than that of air. Suitable dielectric gases include halogenated hydrocarbon gases, such as fluorinated or chloro-fluorinated hydrocarbon gases, and some other fluorine- or halogen-containing gases. One particular fluorinated hydrocarbon gas is octafluorocyclobutane, which is a four-carbon atom ring with a pair of fluorine atoms bonded to each carbon atom. Other organic gases having 1 to 4 carbon atoms with 2 to 4 halogen atoms per carbon atom may be suitable. Such gases tend to have a relatively high density, and the halogen atoms are good charge quenchers. There are several such gases having a dielectric strength and breakdown voltage 2-3 times that of air. In some embodiments, the dielectric gas may be mixed with nitrogen or air to reduce the amount of the more expensive dielectric gas used. In various embodiments, the gas provided in the jet of gas 32 has an average dielectric strength that is 1.1 to 3 times that of air.

It is not required that all three of the illustrated layers 34-38 has a dielectric strength or breakdown voltage that is higher than air, or that all three of the illustrated layers are even present in the gap (G). For instance, when printing conductive inks, the nozzle 12 may act as a dielectric strength-enhancing layer between the electrode 16 and extraction surface 26, with or without a dielectric gas. Or existing e-jet printers with conductive nozzles may be retrofitted to cause a dielectric gas or gas mixture to flow between the nozzle and the extraction surface to incrementally improve breakdown voltage.

Providing one or more such layers between the electrode 16 and extraction surface 26 can improve jetting frequency even with traditional e-jet printing, which relies on the substrate 120 to provide the extraction surface 26 spaced from the ink charging electrode, as in FIG. 3. In this version of the print head 10′, the nozzle 12 is non-conductive, the substrate 120 is conductive, and the printing fluid 20 has a dielectric strength greater than that of air. The electrode-in-nozzle configuration is the same as in FIG. 1 except that the central axis of the nozzle 12 is perpendicular to the printing surface 22 in FIG. 3 rather than forming an oblique angle with the printing surface as in FIG. 1. The extractor 14 and gas nozzle 18 of FIG. 1 are omitted in the example of FIG. 3.

In FIG. 3, the extraction field is thus formed between the electrode 16 and the conductive substrate 120 such that the printing surface 22 and the extraction surface 26 are one and the same. The electrode 16 operates at the first electrical potential (V₁) and the conductive substrate 120 is grounded or otherwise brought to a second electrical potential different from the first. As in FIG. 1, the extraction opening 24 is located within the electric field formed between the electrode 16 and extraction surface 26 so that the charged printing fluid 20 in the nozzle 12 is attracted toward the extraction surface to form a meniscus or Taylor cone 28 at the extraction opening. The extraction field extracts successive droplets 30 of printing fluid from the nozzle 12 for deposition on the printing surface 22. Backpressure (P₁) may or may not be present in the printing nozzle 12.

In this case, there is no solid layer of material (e.g., material of the nozzle 12) in the gap (G) defined at the shortest distance between the electrode 16 and the extraction surface 26. Instead, there is only a first layer 34 of material formed by the non-conductive printing fluid 20 and a layer of gas 38 in the gap (G). There is no jet of gas comprising a dielectric gas in this example, but it is possible to operate the print head 10′ in a dielectric gas environment.

In a proof-of-concept example, a UV-curable optical adhesive was used as the non-conductive printing fluid 20 in the embodiment of FIG. 3 and compared to a traditional e-jet print head equipped with a conductive (i.e., gold-plated) nozzle instead of the intra-nozzle electrode 16 of FIG. 3. Both set-ups used a 27 μm extraction opening 24 and a stand-off height (H) of 200 μm. Using the traditional e-jet set-up with the conductive nozzle, the maximum attainable voltage potential between the nozzle and the extraction surface 26 before arcing was 1400 V, and the maximum operating voltage potential to achieve a single, stable Taylor cone was about 1200 V, resulting in a jetting frequency (extracted droplets per unit time) of about 500-600 Hz. Using the set-up of FIG. 3 with the intra-nozzle electrode 16 and a glass nozzle 12, with the tip 25 of the electrode spaced 100 μm from the extraction opening 24 (i.e., D=G−H=100 μm), the maximum attainable voltage potential between the electrode and the extraction surface 26 before arcing was 2200 V, and the maximum operating voltage potential to achieve a single, stable Taylor cone was about 1500 V, resulting in a jetting frequency of about 900 Hz. Locating at least one layer of material having a dielectric strength greater than air in the gap (G) between the ink-charging electrode 16 and the extraction surface 26 can thus improve jetting frequency by 50% or more. The embodiment of FIGS. 1 and 2 offers similar or better results with the addition of the solid layer 36 of nozzle material in the gap (G).

Notably, in addition to increased jetting frequency, the disclosed print head also has a larger processing window in at least one aspect. In particular, the difference between the arcing voltage and the operating voltage is increased with the layers of material 34-38 in the gap (G). This provides a safety factor such that the operating voltage is not as close to the arcing voltage as with previous e-jet printers.

In another embodiment similar to that of FIG. 3, the printing substrate 120 and surface 22 are non-electrically conductive such that the electrical potential of the extraction surface is floating—i.e., not grounded or controlled to be at any particular potential. It has been found that, with a sufficiently high voltage (e.g., 1500V) applied to the electrode 16 and with a sufficiently small stand-off height (H) (e.g., 200 μm) certain non-conductive substrate materials may become sufficiently polarized so that the exposed surface becomes an extraction surface 26 that will extract charged printing fluid from the nozzle 12. Lower quality glass materials with relatively higher levels of impurities are one suitable family of materials with which this type of e-jet printing is possible. In such cases, it may be important to provide a jet of gas discharged toward the printing surface 22 to reliably direct extracted ink in the desired direction.

Another feature of the disclosed printer 100 is the shape of the electrode 16. As noted above and illustrated in the figures, the electrode 16 may be tapered, with a cross-sectional size that decreases with decreased distance from the tip 25. The electrode 16 may be fabricated from a material comprising tungsten (e.g., a tungsten alloy) or consisting essentially of tungsten. Tungsten is capable of being tapered down to an exceptionally small size via chemical etching. The tip 25 of a tungsten-based electrode 16 may for example have a radius of about 1 μm. This is smaller than even the smallest 50-gauge metal wire, which is about 25 μm in diameter. Moreover, the tapered shape permits a larger and therefore more rigid electrode base at an end opposite the electrode tip 25. For example, a tungsten electrode 16 may have a base diameter between 250 μm and 500 μm which tapers to a tip with a 1 μm radius. While a 20 μm to 30 μm metal wire could be functional, the constant diameter of a wire means that there is less rigidity away from the tip than there is with a 250-500 μm base. Further, a sharper electrode tip provides a higher charge density at the tip, which may be partially responsible for the ability to place high dielectric strength layers between the electrode 16 and the extraction surface 26 while maintaining a sufficient electric field strength to act as an extraction field.

In various embodiments, the electrode 16 may have a diameter of 30 μm or less at its tip, or 20 μm or less at the tip. In other embodiments, the electrode 16 may taper down to 10% or less of its base diameter. For instance, the electrode may taper down to a 2 μm diameter from a base diameter of greater than 200 μm. Materials other than tungsten are contemplated, particularly as technologies develop to hone or otherwise shape other materials (e.g., high-carbon steel) down to a finer edge or point than is currently possible. E-jet printed electrodes 16 are one future possibility, for example.

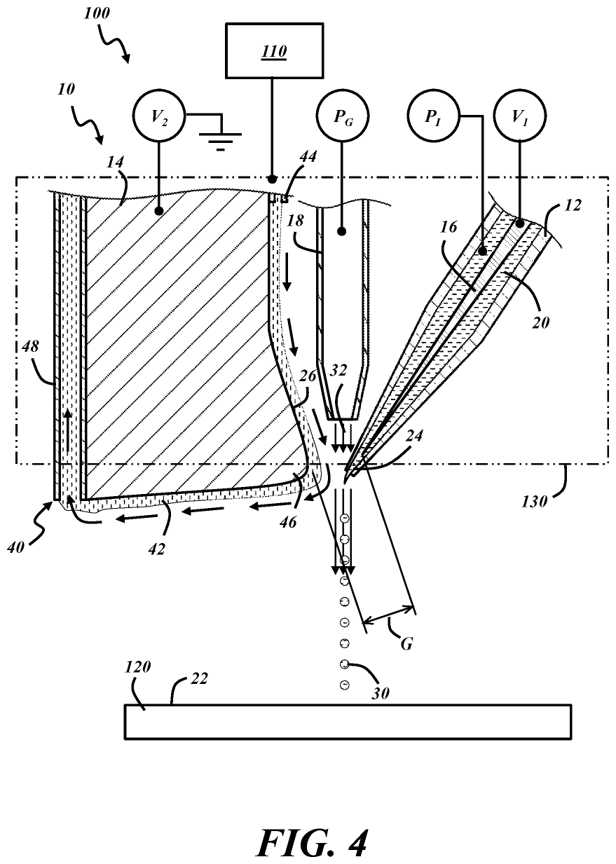

With reference now to FIG. 4, a portion of another e-jet print head 10 and printer 100 is illustrated in a side cross-sectional view. The illustrated print head 10 is identical in many aspects to a previous example, with the same ink nozzle 12, electrode 16, and gas nozzle 18 configuration as in FIGS. 1 and 2. The extraction surface 26 of FIG. 4 is also provided by a metal extractor 14′. In the example of FIG. 4, the extractor 14′ is a self-cleaning extractor, which is any extractor of an e-jet print head wherein the print head includes one or more components configured to clean printing fluid from the extraction surface 26. Such components are an integral part of the print head 10 and move with the print head during printer operation. The self-cleaning extractor 14 eliminates any need to disassemble the print head to clean stray printing fluid from the extractor, which is cleaned and remains clean during printing, even when stray printing fluid is on a trajectory toward the extractor.

In the example of FIG. 4, a cleaning system 40 is configured to provide a layer of cleaning fluid 42 that flows along the extraction surface 26 of the extractor 14′. The cleaning fluid may have a dielectric strength greater than that of air, and the layer of cleaning fluid 42 may have a breakdown voltage greater than that of a similar layer of air. The layer of cleaning fluid 42 flows through the gap (G) and may thus also help to increase the maximum operating voltage of the electrode 16 and, thereby, the jetting frequency of the droplets of printing fluid.

The illustrated extractor 14′ is a metal or metal-containing plate having a thickness (perpendicular to the page) on the order of the outer diameter of the nozzles 12, 18, such as about 5 mm to 8 mm. The cleaning fluid 42 is a liquid, such as an organic solvent (e.g., acetone or an alcohol) in which the printing fluid 20 is soluble, and the layer of cleaning fluid flows from a dispenser 44 of the system 40, vertically downward along the extraction surface 26 and around a bend at a working portion 46 of the extractor, from where it flows horizontally along a downward facing surface of the extractor to a collector 48, which may be a vacuum tube. The dispenser 44 is located along the extraction surface 26 and above the working portion 46, and the collector 48 is located on the opposite side of the extractor 14′ from the dispenser 44. The layer of cleaning fluid 42 is exposed to the atmosphere along at least a portion of the extractor surface. Where exposed to the atmosphere, the layer of cleaning fluid 42 is unsupported by additional printer components and remains attached to the extractor surface against the force of gravity via cohesive forces of the cleaning fluid (e.g., surface tension, viscosity, etc.). The downward facing portion of the extractor 14′ is at a non-zero angle (e.g., about 5 degrees) with respect to horizontal to cause the cleaning fluid to flow in the desired direction away from the working portion 46 of the extractor. The dispenser 44 and collector 48 may take other forms and be located elsewhere on opposite sides of a portion of the surface to be cleaned. In some embodiments, the dispenser 44 and/or the collector 48 may be fluid channels formed in the extractor 14′ and opening at different locations on its surface. The cleaning system 40 may include other non-illustrated components, such as a cleaning fluid reservoir, a pump, a solvent recirculation system, valves, controllers, or connections to similar external components. In other embodiments, the self-cleaning extractor 14′ is or includes a horizontal metal rod with a concentric dispenser at one and a concentric collector at another end, with the cleaning fluid flowing along the outer cylindrical surface of the rod from the dispenser to the collector with the extraction surface therebetween. In that case, the layer of cleaning fluid may also act as a dielectric strength enhancer in the gap (G) between the electrode 16 and the extraction surface 26.

In other examples, the print head 10 and printer may include a non-gaseous layer of material in contact with the extraction surface 26 and in the gap (G). The non-gaseous layer may be a solid (e.g., a film) or liquid having a dielectric strength greater than that of air, thereby permitting a higher voltage potential between the electrode 16 and the extraction surface.

In additional embodiments, the printing fluid 20 in the nozzle may be at a temperature higher than ambient temperature. The electrode 16 may for example be heated during operation, or a reservoir of printing fluid feeding the ink nozzle 12 may be heated. Heating the printing fluid 20 can help increase the jetting frequency of the droplets 30 of extracted fluid by lowering the viscosity of the printing fluid, which is effectively a lowering of intermolecular forces in the fluid, thus causing the extracted droplets 30 to be smaller and, thereby, reduce the time between extraction of successive droplet. Similarly, the jet of gas 32 can be a jet of heated gas at a temperature higher than ambient temperature. With the tip of the ink nozzle 12 located in the jet of heated gas, local viscosity of the printing fluid is reduced with a similar effect.

Embodiments of the above-described print head 10 and printer 100 enable performance of a method of increasing the jetting frequency of an electrohydrodynamic printer. The method may include charging printing fluid 20 in the nozzle 12 of the printer 10 using an electrode 16 at a first electrical potential and forming an extraction field between the electrode and an electrically conductive surface 26 spaced from the electrode by a gap (G). The extraction opening 24 of the nozzle 12 is located in the extraction field so that charged printing fluid is extracted from the nozzle through the extraction opening for deposition on the printing surface 22. At least one of the following is located in the gap (G) when the extraction field is present: non-conductive printing fluid, non-conductive material of the nozzle, a dielectric gas, and a layer of cleaning fluid flowing along the electrically conductive surface.

The above-described print head and printer may offer other advantages and benefits in addition to or other than higher operating voltage and higher jetting frequency. For example, the electrode-in-nozzle configuration offers manufacturing benefits unrelated to voltage and jetting frequency. In particular, the intra-nozzle electrode 16 of the illustrated embodiments offers a simple configuration with which the printing fluid 20 in the nozzle 16 can be charged without any part of the nozzle 12 being conductive. This represents a long-felt and unresolved need in the prior art. Providing the required conductive surfaces has been a continuing problem with e-jet printers. Traditional e-jet printing required a conductive substrate to print on—a problem that was solved in above-mentioned U.S. Pat. No. 9,415,590. But the nozzle still had to be conductive to charge the ink and to act as one side of the extraction field. Fabricating a metal nozzle at the necessary size scale to take advantage of the accuracy of e-jet printing has continued to be a problem. Forming a 20-30 μm hole in the tip of a metal nozzle is not a simple task, for example. And attempting to gold-plate or otherwise metallize a glass or plastic nozzle, particularly at the extraction opening, presents several challenges.

The disclosed printer head and printer addresses these problems in an elegant manner by disposing the charging and field-generating electrode 16 in the nozzle with the tip or distal end 25 of the electrode immersed in the printing fluid. With this configuration, an off-the-shelf glass or plastic nozzle with the desired extraction opening size can be used, thus offering advantages unrelated to operating voltage or jetting frequency. Indeed, in some embodiments, there is no layer of material in the gap (G) between the electrode and the extraction surface 26 that has a breakdown voltage or dielectric strength higher than that of air. While operating voltage and jetting frequency may be the same or lower than conventional e-jet printing in that case, the intra-nozzle electrode 16 offers these other advantages. As such, the disclosed print head and printer can be advantageously used to print aqueous or conductive inks that have a lower breakdown voltage than air.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An electrohydrodynamic printer, comprising:
a nozzle having an extraction opening, the printer being configured to provide printing fluid in the nozzle and at the extraction opening; and
an electrode configured to operate at a first electrical potential to charge the printing fluid in the nozzle and to form an extraction field between the electrode and an extraction surface at a second electrical potential with the extraction opening in the extraction field, whereby charged printing fluid is extracted from the nozzle by the extraction field through the extraction opening for deposition on a printing surface,
wherein a gap is defined at a smallest distance between the electrode and the extraction surface, and
wherein the printer is configured to provide in said gap at least one layer of material having a dielectric strength greater than a dielectric strength of air.

2. The printer of claim 1, wherein the electrode is inside the nozzle and at least partially surrounded by the printing fluid in the nozzle such that the at least one layer of material comprises a layer of the printing fluid.

3. The printer of claim 1, wherein the electrode is inside the nozzle and the nozzle is formed from a non-conductive material such that the at least one layer of material includes a portion of the nozzle.

4. The printer of claim 1, wherein the at least one layer of material includes a layer of dielectric gas flowing through the gap.

5. The printer of claim 1, further comprising an extractor laterally spaced from the nozzle, wherein the extractor provides the extraction surface at the second electrical potential.

6. The printer of claim 5, wherein the at least one layer of material includes a non-gaseous layer in contact with the extraction surface.

7. The printer of claim 6, wherein the extractor is self-cleaning and the non-gaseous layer is a liquid cleaning fluid.

8. The printer of claim 1, further comprising a gas nozzle configured to discharge a jet of gas that directs extracted printing fluid toward the printing surface.

9. The printer of claim 8, wherein the at least one layer of material includes the jet of gas.

10. The printer of claim 8, wherein the gas is heated.

11. The printer of claim 1, wherein the printing surface provides the extraction surface at the second electrical potential, the extraction surface being an electrically conductive surface.

12. The printer of claim 1, wherein the printing surface provides the extraction surface at the second electrical potential, the extraction surface being an electrically non-conductive surface.

13. The printer of claim 1, wherein the electrode is inside the nozzle and does not extend through the extraction opening.

14. The printer of claim 1, wherein an end of the electrode is spaced from the extraction opening by an amount greater than zero and less than or equal to 100 microns.

15. The printer of claim 1, wherein the electrode has a cross-sectional dimension of less than 30 microns.

16. The printer of claim 1, wherein the electrode is tapered toward an end and has a cross-sectional dimension of less than 20 microns.

17. The printer of claim 1, wherein the at least one layer of material comprises a non-conductive material of the nozzle and non-conductive printing fluid.

18. The printer of claim 1, wherein the printing fluid in the nozzle is heated.

19. The printer of claim 1, wherein the nozzle is non-conductive, the extraction opening has a size, the nozzle is spaced from the printing surface by a distance, and the printer has a maximum jetting frequency that is at least 50% greater than a jetting frequency obtained with a conductive nozzle containing the same printing fluid, having the same size extraction opening, and spaced from the printing surface by the same distance.

20. A method of increasing the jetting frequency of an electrohydrodynamic printer, the method comprising:
charging printing fluid in a nozzle of the printer using an electrode at a first electrical potential; and
forming an extraction field between the electrode and an electrically conductive surface spaced from the electrode by a gap, an extraction opening of the nozzle being located in the extraction field so that charged printing fluid is extracted from the nozzle through the extraction opening for deposition on a printing surface,
wherein at least one of the following is located in the gap when the extraction field is present: non-conductive printing fluid, non-conductive material of the nozzle, a dielectric gas, and a layer of cleaning fluid flowing along the electrically conductive surface.

21. An electrohydrodynamic printer, comprising:
a nozzle having an extraction opening, the printer being configured to provide printing fluid in the nozzle and at the extraction opening; and
an electrode configured to operate at a first electrical potential to charge the printing fluid in the nozzle and to form an extraction field between the electrode and an extraction surface at a second electrical potential with the extraction opening in the extraction field, whereby charged printing fluid is extracted from the nozzle by the extraction field through the extraction opening for deposition on a printing surface,
wherein the electrode is inside the nozzle such that an end of the electrode closest to the extraction opening is immersed in the printing fluid in the nozzle.

22. The printer of claim 21, wherein the nozzle is electrically non-conductive.
